(19) United States
(12) Patent Application Publication
(10) Pub. No.: US 2019/0347824 A1
(43) Pub. Date: Nov. 14, 2019

(54) METHOD AND APPARATUS FOR POSITIONING PUPIL, STORAGE MEDIUM, ELECTRONIC DEVICE

(71) Applicants: Beijing BOE Optoelectronics Technology Co., Ltd., Beijing (CN); BOE TECHNOLOGY GROUP CO., LTD., Beijing (CN)

(72) Inventors: Hongzhen XUE, Beijing (CN); Jiankang SUN, Beijing (CN); Minglei CHU, Beijing (CN); Lili CHEN, Beijing (CN)

(21) Appl. No.: 16/288,293

(22) Filed: Feb. 28, 2019

(30) Foreign Application Priority Data
May 14, 2018 (CN) 201810456220.3

(51) Int. Cl. G06T 7/73; G06T 7/60; G06T 5/00; G06T 5/20; G06T 7/13; G06T 7/12; G06K 9/00; G06K 9/38

(52) U.S. Cl. CPC G06T 7/73; G06T 7/60; G06T 5/002; G06T 5/20; G06T 2207/30201; G06T 7/12; G06K 9/0061; G06K 9/38; G06T 7/13

(57) ABSTRACT

A method and an apparatus for positioning a pupil, a storage medium, and an electronic device are provided. The method includes acquiring a plurality of fitting points on a target pupil boundary obtained in an image to be processed, and moving the plurality of fitting points in a preset direction by a preset distance to obtain a plurality of target fitting points; performing ellipse fitting on the plurality of target fitting points according to Cramer's law to obtain an ellipse, and acquiring a center point of the ellipse; moving the center point in a direction opposite to the preset direction by the preset distance, and determining the center point after the movements as the pupil.

### CROSS REFERENCE

This application is based upon and claims priority to Chinese Patent Application No. 201810456220.3, filed on May 14, 2018, the entire contents thereof are incorporated herein by reference.

### TECHNICAL FIELD

The present disclosure relates to the technical field of image processing, and in particular, to a method and an apparatus for positioning a pupil, a storage medium, and an electronic device.

### BACKGROUND

The study on eyes and movement thereof is the key to understanding human visual mechanisms, understanding people's feelings and behaviors, as well as human-computer interaction based on eye movements. Pupil detection and tracking is a necessary step in face recognition, expression recognition, eye movement analysis, iris recognition and other technologies, involving image processing, computer vision, pattern recognition and many other disciplines.

It should be noted that the information disclosed in the Background section above is only for enhancing the understanding of the background of the present disclosure, and thus may include information that does not constitute prior art known to those of ordinary skill in the art.

### SUMMARY

The object of the present disclosure is to provide a method and an apparatus for positioning a pupil, a storage medium, and an electronic device.

According to one aspect of the present disclosure, there is provided a method for positioning a pupil, including:

acquiring an image to be processed, and pre-processing the image to be processed to obtain a binary image;

performing boundary extraction on a pupil candidate area in the binary image to obtain a pupil candidate boundary corresponding to each pupil candidate area;

calculating a length of each pupil candidate boundary, and determining a pupil candidate boundary having the longest length as a target pupil boundary;

acquiring a plurality of fitting points on the target pupil boundary, and moving the plurality of fitting points in a preset direction by a preset distance to obtain a plurality of target fitting points;

performing ellipse fitting on the plurality of target fitting points according to Cramer's law to obtain an ellipse, and acquiring a center point of the ellipse;

moving the center point in a direction opposite to the preset direction by the preset distance, and determining the center point after the movements as the pupil.

In an exemplary embodiment of the present disclosure, pre-processing the image to be processed to obtain a binary image includes:

acquiring a grayscale image of the image to be processed;

performing Gaussian filtering on the grayscale image to obtain a de-noised grayscale image; and

converting the de-noised grayscale image into a binary image through a grayscale threshold.

In an exemplary embodiment of the present disclosure, performing boundary extraction on a pupil candidate area in the binary image to obtain a pupil candidate boundary corresponding to each pupil candidate area includes:

respectively extracting boundary points of each pupil candidate area through a boundary detection algorithm; and

performing connected domain analysis on the boundary points of each pupil candidate area to obtain the pupil candidate boundary corresponding to each pupil candidate area.

In an exemplary embodiment of the present disclosure, acquiring a plurality of fitting points on the target pupil boundary includes:

equally dividing the target pupil boundary into a plurality of boundary segments, and selecting one fitting point on each of the boundary segments, to obtain a plurality of fitting points, and a number of the boundary segments is at least six.

In an exemplary embodiment of the present disclosure, performing boundary extraction on a pupil candidate area in the binary image includes:

performing exposure processing on the binary image to obtain an exposed binary image; and

performing boundary extraction on the pupil candidate area in the exposed binary image.

In an exemplary embodiment of the present disclosure, performing boundary extraction on the pupil candidate area in the exposed binary image includes:

performing an opening operation on the exposed binary image to obtain the binary image after the opening operation; and

performing boundary extraction on the pupil candidate area in the binary image after the opening operation.

In an exemplary embodiment of the present disclosure, performing boundary extraction on a pupil candidate area in the binary image includes:

performing an opening operation on the binary image to obtain the binary image after the opening operation; and

performing boundary extraction on the pupil candidate area in the binary image after the opening operation.

According to one aspect of the present disclosure, there is provided an apparatus for positioning a pupil, including:

a processing module configured acquire an image to be processed, and pre-process the image to be processed to obtain a binary image;

an extraction module configured to perform boundary extraction on a pupil candidate area in the binary image to obtain a pupil candidate boundary corresponding to each pupil candidate area;

a calculation module configured to calculate a length of each pupil candidate boundary, and determine a pupil candidate boundary having the longest length as a target pupil boundary;

an acquisition module configured to acquire a plurality of fitting points on the target pupil boundary, and move the plurality of fitting points in a preset direction by a preset distance to obtain a plurality of target fitting points;

a fitting module configured to perform ellipse fitting on the plurality of target fitting points according to Cramer's law to obtain an ellipse, and acquire a center point of the ellipse; and

a determining module configured to move the center point in a direction opposite to the preset direction by the preset distance, and determine the center point after the movements as the pupil.

According to one aspect of the present disclosure, there is provided a computer readable storage medium having stored thereon a computer program, when being executed by a processor, the computer program implementing the method for positioning a pupil according to any of the above.

According to one aspect of the present disclosure, there is provided an electronic device, including:

a processor; and

a memory for storing instructions executable by the processor;

wherein the processor is configured to perform the method for positioning a pupil according to any of the above by executing the executable instruction.

It should be understood that both the foregoing general description and the following detailed description are exemplary and explanatory only and are not restrictive of the disclosure.

### BRIEF DESCRIPTION OF THE DRAWINGS

The above and other features and advantages of the present disclosure will become more apparent from detailed description of exemplary embodiments with reference to accompanying drawings. Apparently, the drawings in the following description are only some of the embodiments of the present disclosure, and from these drawings, other drawings may be obtained by those skilled in the art without paying creative efforts. In the drawings:

FIG. 1 is a flowchart of a method for positioning a pupil according to the present disclosure;

FIG. 2 is a flowchart of acquiring a binary image according to an exemplary embodiment of the present disclosure;

FIG. 3 is a schematic diagram of a binary image according to an exemplary embodiment of the present disclosure;

FIG. 4 is a schematic diagram of a binary image after an opening operation according to an exemplary embodiment of the present disclosure;

FIG. 5 is a schematic diagram of performing boundary extraction on a pupil candidate area as shown in FIG. 4 according to an exemplary embodiment of the present disclosure;

FIG. 6 is a schematic diagram of obtaining a fitting point according to an exemplary embodiment of the present disclosure;

FIG. 7 is a block diagram of an apparatus for positioning a pupil according to the present disclosure;

FIG. 8 is a block diagram of an electronic device according to an exemplary embodiment of the present disclosure; and

FIG. 9 is a schematic diagram of a program product according to an exemplary embodiment of the present disclosure.

### DETAILED DESCRIPTION

Exemplary embodiments will now be described more fully with reference to the accompanying drawings. However, the exemplary embodiments can be embodied in a variety of forms and should not be construed as being limited to the examples set forth herein. Rather, these embodiments are provided so that the present disclosure will be thorough and complete, and to fully convey the concept of the exemplary embodiments to those skilled in the art. The same reference numerals in the drawings denote the same or similar parts, and the repeated description thereof will be omitted.

In addition, the described features, structures, or characteristics may be combined in any suitable manner in one or more embodiments. In the following description, numerous specific details are set forth to facilitate thorough understanding of the embodiments of the present disclosure. However, one skilled in the art will appreciate that one or more of the specific details may be omitted or other methods, components, materials, devices, steps, etc. may be implemented. In other instances, structures, methods, devices, implementations, materials or operations that are well known in the art will not be illustrated or described in detail, to avoid obscuring the various aspects of the present disclosure.

The blocks shown in the figures are merely functional entities and do not necessarily have to correspond to physically separate entities. That is, these functional entities may be implemented in software, or these functional entities or part of them may be implemented in one or more software-hardened modules, or these functional entities may be implemented in separate networks and/or processor devices and/or microcontroller devices.

At present, the pupil positioning algorithm is very common and the positioning can be very accurate. However, the existing pupil positioning algorithm has a large amount of computation and a high demand for storage space. Therefore, the existing pupil positioning algorithm has to be run on a PC side and cannot be run on a field programmable gate array (FPGA). To run on a FPGA, a pupil positioning algorithm with a small amount of computation and low storage space requirements is required.

Accordingly, the present disclosure is to provide a pupil positioning algorithm that can be run on a FPGA.

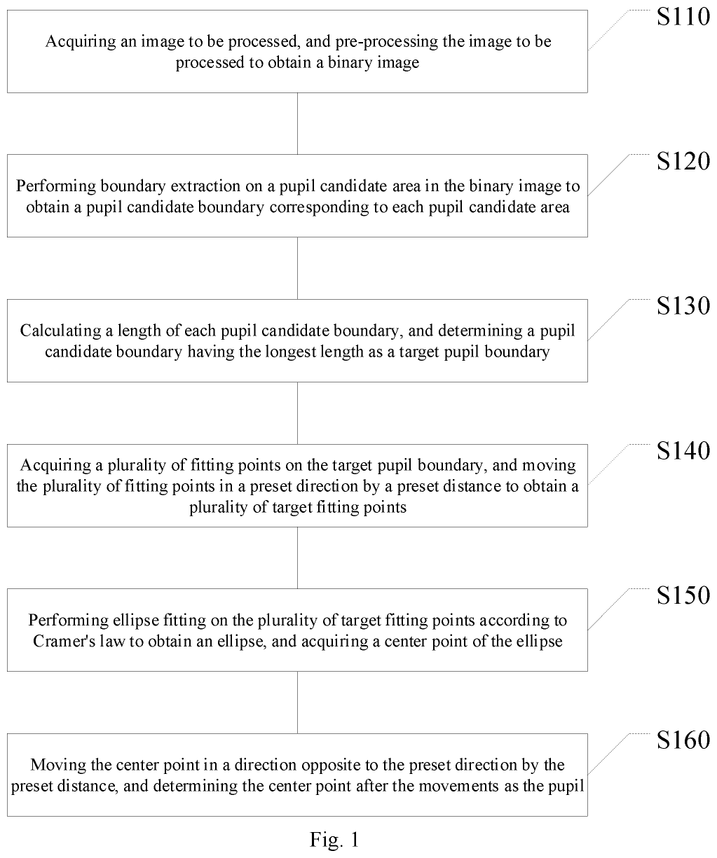

A method for positioning a pupil is first disclosed in an exemplary embodiment. Referring to FIG. 1, the method for positioning a pupil may include the following steps.

In Step S110, an image to be processed is acquired, and the image to be processed is pre-processed to obtain a binary image.

In Step S120, boundary extraction is performed on a pupil candidate area in the binary image to obtain a pupil candidate boundary corresponding to each pupil candidate area.

In Step S130, a length of each pupil candidate boundary is calculated, and a pupil candidate boundary having the longest length is determined as a target pupil boundary.

In Step S140, a plurality of fitting points are acquired on the target pupil boundary, and the plurality of fitting points are moved in a preset direction by a preset distance to obtain a plurality of target fitting points.

In Step S150, ellipse fitting is performed on the plurality of target fitting points according to Cramer's law to obtain an ellipse, and the center point of the ellipse is acquired.

In Step S160, the center point is moved in a direction opposite to the preset direction by the preset distance, and the center point after the movements is determined as the pupil.

According to the method for positioning a pupil in the exemplary embodiment, on the one hand, a plurality of fitting points are moved in a preset direction by a preset distance to obtain a plurality of target fitting points, and elliptical fitting is performed on the plurality of target fitting points. Compared with directly performing ellipse fitting on the plurality of fitting points, the calculation amount can be reduced, and the operation bit width of the FPGA can also be greatly reduced. On the other hand, a FPGA cannot perform calculation on floating point numbers, while performing ellipse fitting on the plurality of target fitting points according to Cramer's law does not generate floating point numbers. Therefore, performing ellipse fitting on the plurality of target fitting points according to Cramer's law makes it possible for the method for positioning a pupil to be run on a FPGA. Moreover, since no floating point number is generated during the operation, compared with calculation method that generates floating point numbers, it can avoid the problem of accumulating arithmetic error caused by continuous operation on floating point numbers, thereby greatly reducing the operation error, the calculation amount, and the storage space, improving the efficiency and accuracy of the operation, and making the positioning of the pupil more accurate. In another aspect, after performing fitting on the plurality of target fitting points, the acquired central point is moved in a direction opposite to the preset direction by the preset distance, which can ensure the accuracy of the final position of the center point.

Hereinafter, the method for positioning a pupil in the exemplary embodiment will be further described with reference to FIG. 1.

In step S110, an image to be processed is acquired, and the image to be processed is pre-processed to obtain a binary image.

In the exemplary embodiment, the image to be processed may be acquired by an image acquisition device, and the image acquisition device may be, for example, a camera, a mobile phone, or the like, which is not specifically limited in this exemplary embodiment. The image to be processed may include an eyeball and an eyelid area. It should be noted that, since the original image acquired by the image acquiring device may include the entire face area, when the acquired original image includes the entire face area, the eyeball and the eyelid area may be intercepted from the entire face area, to obtain an image to be processed.

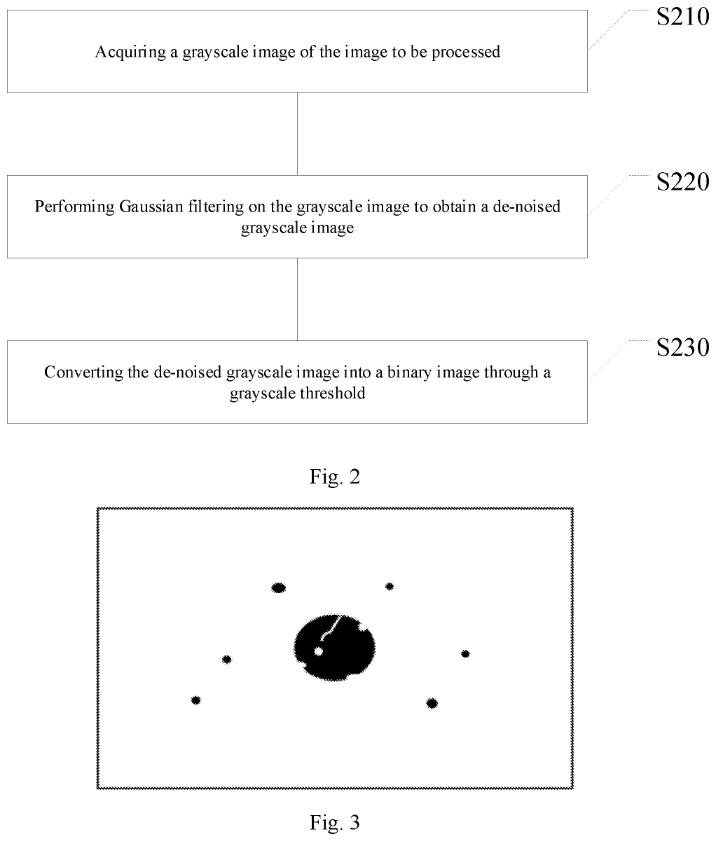

As shown in FIG. 2, pre-processing the image to be processed to obtain a binary image may include steps S210 to S230.

In step S210, a grayscale image of the image to be processed is acquired.

In the exemplary embodiment, acquiring the grayscale image of the image to be processed may be performed by one of the following two approaches.

The first approach may be: acquiring components of each pixel in the image to be processed on three channels of RGB, and respectively calculating the gray value of each pixel according to the following formula to obtain the grayscale image of the image to be processed.

f(i,j)=0.30R(i,j)+0.59G(i,j)+0.11B(i,j)

Where, f(i,j) denotes a gray value of a pixel on an i-th row and a j-th column, R(i,j) denotes a component of a pixel on an i-th row and a j-th column on the R channel, the G(i,j) denotes a component of a pixel on an i-th row and a j-th column on the G channel, and B(i,j) denotes a component of a pixel on an i-th row and a j-th column on the B channel.

The second approach may be: acquiring components of each pixel in the image to be processed on three channels of RGB, and respectively calculating the gray value of each pixel according to the following formula to obtain the grayscale image of the image to be processed.

f(i,j)=(R(i,j)+G(i,j)B(i,j))/3

Where, f(i,j) denotes a gray value of a pixel on an i-th row and a j-th column, R(i,j) denotes a component of a pixel on an i-th row and a j-th column on the R channel, the G(i,j) denotes a component of a pixel on an i-th row and a j-th column on the G channel, and B(i,j) denotes a component of a pixel on an i-th row and a j-th column on the B channel.

It should be noted that the approaches of obtaining the grayscale image of the image to be processed is merely exemplary and is not intended to limit the present disclosure.

In step S220, Gaussian filtering is performed on the grayscale image to obtain a de-noised grayscale image.

In the exemplary embodiment, the process of performing Gaussian filtering on the grayscale image may include: acquiring grayscale values of each pixel and its surrounding pixels; and respectively calculating a weighted average of the grayscale values of the pixel and its surrounding pixels; taking the weighted average of the gray values of the pixel and its surrounding pixels as the gray value of the pixel. That is, the gray value of each pixel is replaced by the weighted average of the gray values of the pixel and its surrounding pixels. By performing Gaussian filtering on the grayscale image, the grayscale image is smoothed to reduce noises.

In step S230, the de-noised grayscale image is converted into a binary image through a grayscale threshold.

In the exemplary embodiment, approaches for determining the grayscale threshold may be various, and may be selected according to actual needs. For example, an approach for determining the grayscale threshold may be: acquiring gray values of pixels in the grayscale image, and calculating an average grayscale value of the pixels. That is, the average gray value of the pixels is obtained by adding the grayscale values of all the pixels and dividing the sum by a total number of the pixels, and the average gray value is determined as the gray threshold. As another example, an approach for determining the grayscale threshold may be: obtaining a maximum grayscale value according to a grayscale value of each pixel in the grayscale image, and determining one third of the maximum grayscale value as the grayscale threshold.

The process of converting the grayscale image into a binary image may include: respectively comparing the grayscale value of each pixel with the grayscale threshold, labeling a pixel having a grayscale value larger than or equal to the grayscale threshold as 0, and a pixel having a grayscale value smaller than the grayscale threshold as 1, to convert the grayscale image into a binary image. For example, a schematic diagram of a binary image is shown in FIG. 3.

In step S120, boundary extraction is performed on a pupil candidate area in the binary image to obtain a pupil candidate boundary corresponding to each pupil candidate area.

In the exemplary embodiment, the pupil candidate area may be acquired from the binary image through cluster analysis. The specific process may include: traversing the pixels in the binary image, and merging pixels closest to each other and are labeled as 1, to obtain a pupil candidate area. It should be noted that, the number of pupil candidate areas may be zero or one, or two or three. It should be noted that when the number of pupil candidate areas is zero, the calculation is directly stopped, and the user is prompted to provide an image to be processed.

Performing boundary extraction on a pupil candidate area in the binary image to obtain a pupil candidate boundary corresponding to each pupil candidate area may include: respectively extracting boundary points of each pupil candidate area through a boundary detection algorithm; performing connected domain analysis on the boundary points of each pupil candidate area to obtain the pupil candidate boundary corresponding to each pupil candidate area.

In the exemplary embodiment, the boundary detection algorithm may be, for example, a Canny boundary detection algorithm, a Soble boundary detection algorithm, or the like, which is not specifically limited in this exemplary embodiment. By processing the binary image with the boundary detection algorithm, the boundary points of each pupil candidate area can be obtained. When the boundary points of the pupil candidate areas are determined, each boundary point is labeled as 1, and points other than the boundary of each pupil candidate area are labeled as 0.

After extracting the boundary points of each pupil candidate area, the specific process of performing connected domain analysis to obtain the pupil candidate boundary may be: traversing the binary image, merging adjacent points labeled as 1 in the binary image, and taking each boundary after the merging as a pupil candidate boundary. The connected domain analysis may be a 4-connected domain analysis, or may be an 8-connected domain analysis, etc., which is not specifically limited in this exemplary embodiment. Since for connected domain analysis, only a binary image of the boundary points in one frame of image has to be buffered, it can greatly save memory space compared with buffering a frame of grayscale image.

In order to improve the accuracy of the boundary extraction of the pupil candidate area, performing boundary extraction on the pupil candidate area in the binary image may include: performing exposure processing on the binary image to obtain the exposed binary image, and performing boundary extraction on the pupil candidate area in the exposed binary image.

In the exemplary embodiment, for an overexposed binary image, the exposure degree of the binary image can be adjusted to reduce the exposure degree of the binary image, such that the boundary of the pupil candidate area in the binary image can be clearer. For an underexposed binary image, the exposure degree of the binary image can be adjusted to improve the exposure degree of the binary image, such that the boundary of the pupil candidate area in the binary image can be clearer. Apparently, the boundary of the pupil candidate area can be made clearer by the exposure processing, thereby improving the accuracy of the boundary extraction of the pupil candidate area.

It should be noted that the approaches of performing boundary extraction on the pupil candidate area in the binary image after the exposure processing are the same as the approaches of performing boundary extraction on the pupil candidate area in step S120, and therefore will not be repeated herein.

In addition, performing boundary extraction on the pupil candidate area in the exposed binary image may include: performing an opening operation on the exposed binary image to obtain the binary image after the opening operation; and performing boundary extraction on the pupil candidate area in the binary image after the opening operation.

In the exemplary embodiment, performing an opening operation on the exposed binary image includes: firstly performing an etching operation on the exposed binary image, and performing an expansion operation on the binary image after the etching operation. Specifically, firstly an etching operation is performed on the exposed binary image with an M*N matrix, and then an expansion operation is performed on the binary image after the etching operation. The M*N matrix may be set by a developer. For example, the M*N matrix is a matrix of 3*3 and the value is all 1, but the exemplary embodiment is not limited thereto. It should be noted that the M*N matrix used for the etching operation and the M*N matrix used for the expansion operation may be the same or different, and the exemplary embodiment does not particularly limit this.

By performing opening operation on the exposed binary image, it is possible to eliminate smaller noise points (for example, dark spots, that is, interference points) in the exposed binary image, and smooth the contour of the boundary. Based on this, since the small noise points, that is, the interference points, are eliminated, the accuracy of the extraction boundary can be improved, thereby improving the accuracy of the pupil positioning, and reducing the calculation amount of the boundary extraction and boundary calculation in the later stage, thereby improving the calculation efficiency, which can in turn increase the efficiency of pupil positioning.

It should be noted that, the approach for performing boundary extraction on the pupil candidate area in the binary image after the opening operation is the same as the approach for performing boundary extraction on pupil candidate area in step S120, and therefore will not be repeated herein.

In addition, performing boundary extraction on the pupil candidate area in the binary image may include: performing an opening operation on the binary image to obtain the binary image after the opening operation; and performing boundary extraction on the pupil candidate area in the binary image after the opening operation.

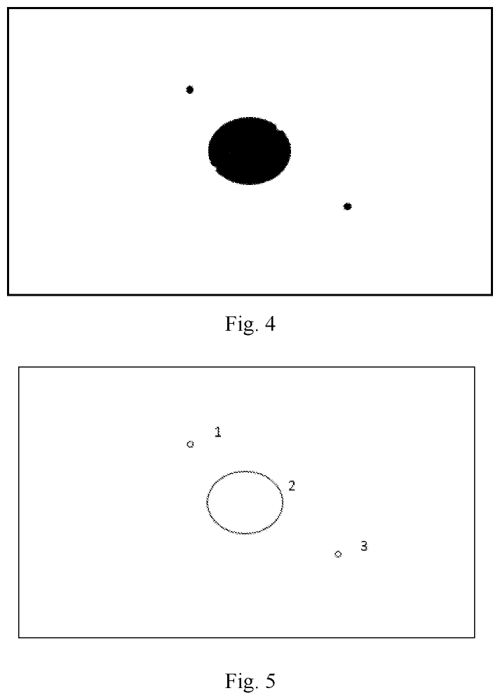

In the exemplary embodiment, since the approach for performing the opening operation on the binary image is the same as the above-described approach for performing the opening operation on the exposed binary image, it will not be repeated herein. Since the approach for performing boundary extraction on the pupil candidate area in the binary image after the opening operation is the same as the approach for performing boundary extraction on the pupil candidate area in step S120, details are not repeated herein. The binary image after the opening operation of FIG. 3 is shown in FIG. 4. As can be seen from the figure, the smaller noise points in FIG. 4 have been eliminated with respect to FIG. 3. FIG. 5 is a schematic diagram showing the pupil candidate area in FIG. 4 after the boundary extraction.

By performing opening operation on the binary image, it is possible to eliminate smaller noise points (for example, dark spots, that is, interference points) in the exposed binary image, and smooth the contour of the boundary. Based on this, since the small noise points, that is, the interference points, are eliminated, the accuracy of the extraction boundary can be improved, thereby improving the accuracy of the pupil positioning, and reducing the calculation amount of the boundary extraction and boundary calculation in the later stage, thereby improving the calculation efficiency, which can in turn increase the efficiency of pupil positioning.

In step S130, a length of each pupil candidate boundary is calculated, and a pupil candidate boundary having the longest length is determined as a target pupil boundary.

In the exemplary embodiment, the coordinates of each boundary point of each pupil candidate boundary may be acquired, and the length of each pupil candidate boundary may be calculated according to the coordinates of each boundary point of each pupil candidate boundary. After obtaining the length of each pupil candidate boundary, the pupil candidate boundary having the longest length can be obtained by comparison with each other, and the pupil candidate boundary having the longest length is determined as the target pupil boundary. It should be understood that if there are more than one pupil candidate boundary having the longest length, any one of them may be selected as the target pupil boundary.

In step S140, a plurality of fitting points are acquired on the target pupil boundary, and the plurality of fitting points are moved in a preset direction by a preset distance to obtain a plurality of target fitting points.

In the exemplary embodiment, a plurality of fitting points can be acquired on the target pupil boundary by an acquisition module. The number of fitting points can be determined according to actual needs, but the number of fitting points is at least six. The fitting points may be arranged at equal intervals on the target pupil boundary, or may be randomly arranged, etc., which is not specifically limited in this exemplary embodiment.

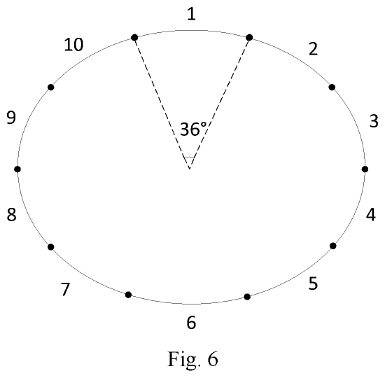

There are many ways to obtain a plurality of fitting points on the target pupil boundary. For example, the target pupil boundary may be equally divided into a plurality of boundary segments, and one fitting point is selected on each of the boundary segments. To obtain a plurality of fitting points. The number of boundary segments is at least six, as shown in FIG. 6. When the number of fitting points is 10, the target pupil boundary can be divided into 10 boundary segments, the angle corresponding to each boundary segment is 36 degrees, and one fitting point is taken on each boundary segment to obtain 10 fitting points. As another example, the plurality of fitting points may also be randomly acquired on the target pupil boundary.

The preset direction and the preset distance may be set according to actual conditions. For example, the preset direction may be the upper left, the lower left, or the upper right and so on. The exemplary embodiment is not particularly limited. For example, the preset distance may be 1 cm, 1.5 cm, or 2 cm, and the exemplary embodiment is not particularly limited thereto.

In step S150, ellipse fitting is performed on the plurality of target fitting points according to Cramer's law to obtain an ellipse, and the center point of the ellipse is acquired.

In the exemplary embodiment, since the Cramer's law is a well known theorem for solving a linear equation system in linear algebra, it will not be described again here. The process of perform ellipse fitting on the plurality of target fitting points is: substituting the coordinates of each target fitting point into the following elliptic formula to obtain a plurality of elliptic formulas to be solved; using Kramer's law to solve the ellipse formulas to obtain the specific values of the six coefficients (i.e., a, b, c, d, e, f) in the elliptic formulas, and then the ellipse matching the plurality of target fitting points can be obtained.

The ellipse formula is:

aX′+bY′+cXY+dX+eY+f=0

Where a, b, c, d, e, and f are the coefficients in the ellipse formula, X denotes the coordinate of the target fitting point on the X axis, and Y denotes the coordinate of the target fitting point on the Y axis.

After obtaining the specific values of the coefficients in the elliptic formula, the center point of the ellipse is calculated by each coefficient.

In step S160, the center point is moved in a direction opposite to the preset direction by the preset distance, and the center point after the movements is determined as the pupil.

In the exemplary embodiment, the center point is moved in a direction opposite to the preset direction in step S140 by a distance equal to the preset distance in step S140, and the position of the pupil can be obtained, that is, the center point after the movement may be determined as the pupil.

It can be seen from the above, a plurality of fitting points are moved in a preset direction to obtain a plurality of target fitting points, that is, a plurality of fitting points with larger coordinate values are converted into a plurality of target objects with smaller coordinate values. In comparison with directly performing ellipse fitting on the plurality of fitting points, performing ellipse fitting on the plurality of target fitting points can greatly reduce the amount of calculation. Since after the fitting of the plurality of target fitting points, the acquired center point is moved in a direction opposite to the preset direction by the preset distance, it can ensure the accuracy of the position of the center point finally obtained. In addition, since a plurality of fitting points with large coordinate values are converted into a plurality of target fitting points with small values, the operation bit width of the FPGA can be greatly reduced. For example, the coordinates of a fitting point are (902, 903), and the fitting point is respectively shifted in the negative direction by 900 on the X-axis and the Y-axis, and the coordinates of the obtained target fitting point are (2, 3). Since the binary representation of the coordinates (902, 903) is: (1110000110, 1110000111), and the binary representation of the coordinates (2, 3) is: (10, 11), apparently, directly performing ellipse fitting on the plurality of fitting points requires ten operation bit width, while performing ellipse fitting on the plurality of target fitting points requires only 2 operation bit width, which greatly reduces the operation bit width of the FPGA. In addition, the characteristic of Kramer's law is that each calculation step is an integer operation, and no floating point number is generated, thereby solving the problem that the FPGA cannot operate on floating point numbers, so that the method for positioning a pupil can be run on the FPGA. Moreover, since no floating point number is generated in any calculation step of Kramer's law, compared with the operation method that continuously generates floating point numbers, the problem of continuous accumulation of operation errors caused by continuous operation of floating point numbers can be avoided. It can greatly reduce the operation error, the calculation amount and the storage space, improve the efficiency and accuracy of the operation, and improve the accuracy in positioning of the pupil.

It should be noted that, in order not to affect the processing of the image to be processed in the next frame and the real-time performance of the pupil positioning, the above-described processing of the connected domain analysis and the ellipse fitting may be performed in the frame blanking area.

It should be noted that, although the various steps of the method of the present disclosure are described in a particular order in the drawings, this does not require or imply that the steps must be performed in the specific order, or that all the steps shown must be performed to achieve the desired results. Additionally or alternatively, certain steps may be omitted, multiple steps being combined into one step, and/or one step may be decomposed into multiple steps, and so on.

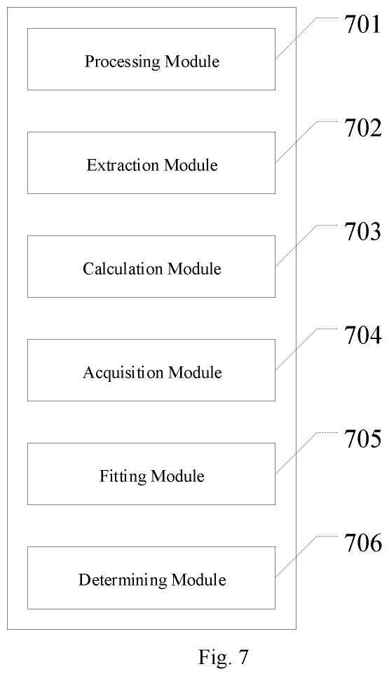

In an exemplary embodiment of the present disclosure, an apparatus for positioning a pupil is further provided. As shown in FIG. 7, the apparatus 700 for positioning a pupil may include a processing module 701, an extraction module 702, a calculation module 703, an acquisition module 704, a fitting module 705 and a determining module 706.

The processing module 701 may be configured acquire an image to be processed, and pre-process the image to be processed to obtain a binary image.

The extraction module 702 may be configured to perform boundary extraction on a pupil candidate area in the binary image to obtain a pupil candidate boundary corresponding to each pupil candidate area.

The calculation module 703 may be configured to calculate a length of each pupil candidate boundary, and determine a pupil candidate boundary having the longest length as a target pupil boundary.

The acquisition module 704 may be configured to acquire a plurality of fitting points on the target pupil boundary, and move the plurality of fitting points in a preset direction by a preset distance to obtain a plurality of target fitting points.

The fitting module 705 may be configured to perform ellipse fitting on the plurality of target fitting points according to Cramer's law to obtain an ellipse, and acquire the center point of the ellipse.

The determining module 706 may be configured to move the center point in a direction opposite to the preset direction by the preset distance, and determine the center point after the movements as the pupil.

The specific details of each module of the apparatus for positioning a pupil described above have been described in detail in the corresponding method for positioning a pupil, and thus will not be repeated herein.

It should be noted that although several modules or units of an apparatus for execution are mentioned in the detailed description above, such division is not mandatory. In fact, features and functions of two or more of the modules or units described above may be embodied in one module or unit in accordance with the embodiments of the present disclosure. On the other hand, the features and functions of one module or unit described above may be further divided into multiple modules or units.

In an exemplary embodiment of the present disclosure, an electronic device capable of implementing the above method is also provided.

It should be appreciated by those skilled in the art that various aspects of the present disclosure can be implemented as a system, method, or program product. Therefore, various aspects of the present disclosure may be embodied in the form of a complete hardware implementation, a complete software implementation (including firmware, microcode, etc.), or a combination of hardware and software, which may be collectively referred to as “circuit”, “module” or “system”.

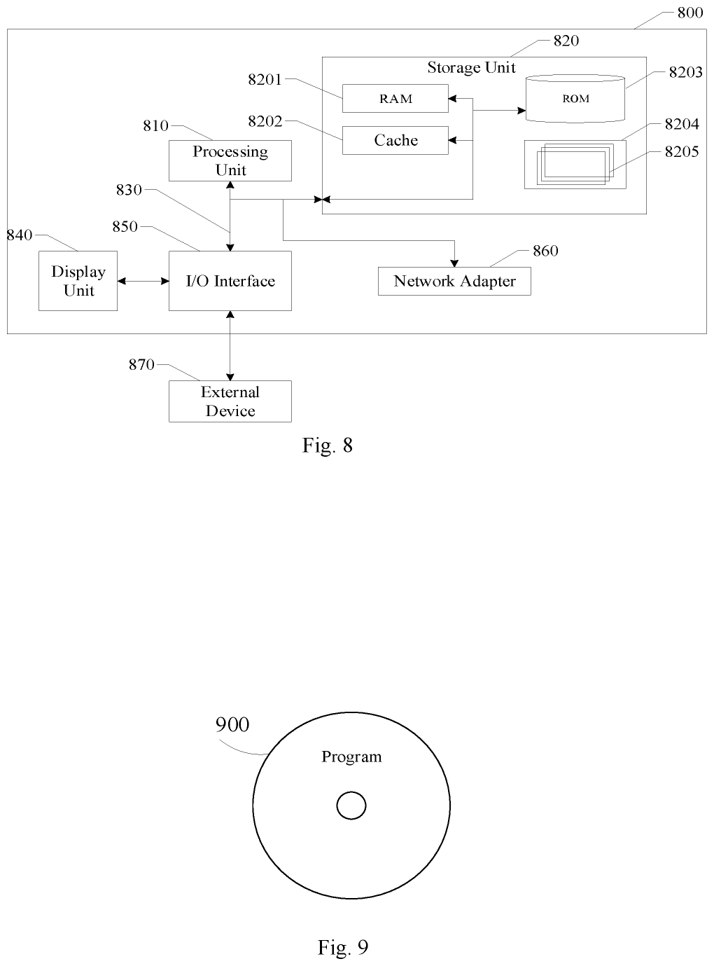

An electronic device 800 in accordance with such an embodiment of the present disclosure is described below with reference to FIG. 8. The electronic device 800 shown in FIG. 8 is merely an example and should not impose any limitation on the function and application scope of the embodiments of the present disclosure.

As shown in FIG. 8, the electronic device 800 is embodied in the form of a general purpose computing device. The components of the electronic device 800 may include, but are not limited to, the at least one processing unit 810, the at least one storage unit 820, a bus 830 connecting different system components (including the storage unit 820 and the processing unit 810), and a display unit 840.

The storage unit stores program codes, which can be executed by the processing unit 810, such that the processing unit 810 performs the steps according to the various exemplary embodiments of the present disclosure described in the present specification. For example, the processing unit 810 may perform Step S110 as shown in FIG. 1, acquiring an image to be processed, and pre-processing the image to be processed to obtain a binary image; Step S120, performing boundary extraction on a pupil candidate area in the binary image to obtain a pupil candidate boundary corresponding to each pupil candidate area; Step S130, calculating a length of each pupil candidate boundary, and determining a pupil candidate boundary having the longest length as a target pupil boundary; Step S140, acquiring a plurality of fitting points on the target pupil boundary, and moving the plurality of fitting points in a preset direction by a preset distance to obtain a plurality of target fitting points; Step S150, performing ellipse fitting on the plurality of target fitting points according to Cramer's law to obtain an ellipse, and acquiring the center point of the ellipse; Step S160, moving the center point in a direction opposite to the preset direction by the preset distance, and determining the center point after the movements as the pupil.

The storage unit 820 may include a readable medium in the form of a volatile storage unit, such as a random access storage unit (RAM) 8201 and/or a cache unit 8202, and may further include a read only storage unit (ROM) 8203.

The storage unit 820 may also include a program/utility 8204 having a group (at least one) of program modules 8205. Such program modules 8205 includes but not limited to: an operating system, one or more applications, other program modules, and program data. Implementation of network environment may be included in each or some combinations of these examples.

The bus 830 can represent one or more of several types of bus structures, including a memory unit bus or a memory unit controller, a peripheral bus, a graphics acceleration port, a processing unit, or a local area bus using any of a variety of bus structures.

The electronic device 800 may also communicate with one or more external devices 870 (e.g., a keyboard, a pointing device, a Bluetooth device, etc.), and may also communicate with one or more devices that enable the user to interact with the electronic device 800, and/or communicate with any device (e.g., router, modem, etc.) that enables the electronic device 800 to communicate with one or more other computing devices. Such communication can take place via an input/output (I/O) interface 850. Also, electronic device 800 can communicate with one or more networks (e.g., a local area network (LAN), a wide area network (WAN), and/or a public network, such as the Internet) through a network adapter 860. As shown, the network adapter 860 is configured to communicate with other modules of electronic device 800 via the bus 830. It should be understood that although not shown in the figures, other hardware and/or software modules may be utilized in conjunction with electronic device 800, including but not limited to: micro-code, a device driver, a redundant processing unit, an external disk drive array, a RAID system, a tape drive and a data backup storage system, and so on.

Through the description of the above embodiments, those skilled in the art will readily understand that the exemplary embodiments described herein may be implemented by software or by software in combination with necessary hardware. Therefore, the technical solution according to an embodiment of the present disclosure may be embodied in the form of a software product, which may be stored in a non-volatile storage medium (which may be a CD-ROM, a USB flash drive, a mobile hard disk, etc.) or on a network. A number of instructions are included to cause a computing device (which may be a personal computer, a server, a terminal device, or a network device, etc.) to perform a method in accordance with an embodiment of the present disclosure.

In an exemplary embodiment of the present disclosure, there is also provided a computer readable storage medium having stored thereon a program product capable of implementing the above method of the present specification. In some possible implementations, aspects of the present disclosure may also be embodied in the form of a program product containing program codes, and when the program product is run on a terminal device, the program codes causes the terminal device to perform the steps according to the various exemplary embodiments of the present disclosure described in the present specification.

Referring to FIG. 9, a program product 900 for implementing the above method is illustrated in accordance with an embodiment of the present disclosure, which may be a portable compact disk read only memory (CD-ROM) and contains program codes, and may be in a terminal device, for example running on a personal computer. However, the program product of the present disclosure is not limited thereto, and in the present description, the readable storage medium may be any tangible medium containing or storing a program that can be used by or in connection with a system, an apparatus or a device for executing instructions.

The program product can be any combination of one or more readable media. The readable medium can be a readable signal medium or a readable storage medium. The readable storage medium can be, for example, but not limited to, an electronic, magnetic, optical, electromagnetic, infrared, or semiconductor system, apparatus, or device, or any combination of the above. More specific examples (non-exhaustive lists) of readable storage media include: electrical connections with one or more wires, a portable disk, a hard disk, a random access memory (RAM), a read only memory (ROM), an erasable programmable read-only memory (EPROM or flash memory), an optical fiber, a portable compact disk read only memory (CD-ROM), an optical storage device, a magnetic storage device, or any suitable combination of the foregoing.

The computer readable signal medium may include a data signal that is propagated in the baseband or as part of a carrier, carrying readable program codes. Such propagated data signals can take a variety of forms including, but not limited to, electromagnetic signals, optical signals, or any suitable combination of the foregoing. The readable signal medium can also be any readable medium other than a readable storage medium that can transmit, propagate or transport a program for use by or in connection with a system, an apparatus or a device for executing instructions.

The program codes embodied on a readable medium can be transmitted by any suitable medium, including but not limited to wireless, wireline, optical cable, RF, etc., or any suitable combination of the foregoing.

The program codes for performing the operations of the present disclosure may be written in any combination of one or more programming languages, including an object oriented programming language such as Java, C++, etc., including conventional procedural programming language such as “C” language or a similar programming language. The program codes can execute entirely on a user computing device, partially on user equipment, as a stand-alone software package, partially on a remote computing device on the user computing device, or entirely on the remote computing device or a server. In the case of a remote computing device is involved, the remote computing device can be connected to the user computing device via any kind of network, including a local area network (LAN) or a wide area network (WAN), or can be connected to an external computing device (e.g., connected via the Internet through an Internet service provider).

Further, the above-described drawings are merely illustrative of the processes included in the method according to the exemplary embodiments of the present disclosure, and are not intended to be limiting. It will be readily understood that the processing shown in the above figures does not indicate or limit the chronological order of these processes. In addition, it will also be readily understood that these processes may be performed synchronously or asynchronously, for example, in a plurality of modules.

In the method and the apparatus for positioning a pupil, the storage medium and the electronic device provided by the exemplary embodiments of the present disclosure. An image to be processed is acquired, and the image to be processed is pre-processed to obtain a binary image; boundary extraction is performed on a pupil candidate area in the binary image to obtain a pupil candidate boundary corresponding to each pupil candidate area; a length of each pupil candidate boundary is calculated, and a pupil candidate boundary having the longest length is determined as a target pupil boundary; a plurality of fitting points are acquired on the target pupil boundary, and the plurality of fitting points are moved in a preset direction by a preset distance to obtain a plurality of target fitting points; ellipse fitting is performed on the plurality of target fitting points according to Cramer's law to obtain an ellipse, and the center point of the ellipse is acquired; and the center point is moved in a direction opposite to the preset direction by the preset distance, and the center point after the movements is determined as the pupil. On the one hand, a plurality of fitting points are moved in a preset direction by a preset distance to obtain a plurality of target fitting points, and elliptical fitting is performed on the plurality of target fitting points. Compared with directly performing ellipse fitting on the plurality of fitting points, the calculation amount can be reduced, and the operation bit width of the FPGA can also be greatly reduced. On the other hand, a FPGA cannot perform calculation on floating point numbers, while performing ellipse fitting on the plurality of target fitting points according to Cramer's law does not generate floating point numbers. Therefore, performing ellipse fitting on the plurality of target fitting points according to Cramer's law makes it possible for the method for positioning a pupil to be run on a FPGA. Moreover, since no floating point number is generated during the operation, compared with calculation method that generates floating point numbers, it can avoid the problem of accumulating arithmetic error caused by continuous operation on floating point numbers, thereby greatly reducing the operation error, the calculation amount, and the storage space, improving the efficiency and accuracy of the operation, and making the positioning of the pupil more accurate. In another aspect, after performing fitting on the plurality of target fitting points, the acquired central point is moved in a direction opposite to the preset direction by the preset distance, which can ensure the accuracy of the final position of the center point.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the disclosure only be limited by the appended claims.

What is claimed is:

1. A method for positioning a pupil, comprising:
acquiring an image to be processed, and pre-processing the image to be processed to obtain a binary image;
performing boundary extraction on a pupil candidate area in the binary image to obtain a pupil candidate boundary corresponding to each pupil candidate area;
calculating a length of each pupil candidate boundary, and determining a pupil candidate boundary having the longest length as a target pupil boundary;
acquiring a plurality of fitting points on the target pupil boundary, and moving the plurality of fitting points in a preset direction by a preset distance to obtain a plurality of target fitting points;
performing ellipse fitting on the plurality of target fitting points according to Cramer's law to obtain an ellipse, and acquiring a center point of the ellipse;
moving the center point in a direction opposite to the preset direction by the preset distance, and determining the center point after the movements as the pupil.

2. The method for positioning a pupil according to claim 1, wherein the step of pre-processing the image to be processed to obtain a binary image comprises:
acquiring a grayscale image of the image to be processed;
performing Gaussian filtering on the grayscale image to obtain a de-noised grayscale image; and
converting the de-noised grayscale image into a binary image through a grayscale threshold.

3. The method for positioning a pupil according to claim 1, wherein the step of performing boundary extraction on a pupil candidate area in the binary image to obtain a pupil candidate boundary corresponding to each pupil candidate area comprises:
respectively extracting boundary points of each pupil candidate area through a boundary detection algorithm; and
performing connected domain analysis on the boundary points of each pupil candidate area to obtain the pupil candidate boundary corresponding to each pupil candidate area.

4. The method for positioning a pupil according to claim 1, wherein the step of acquiring a plurality of fitting points on the target pupil boundary comprises:
equally dividing the target pupil boundary into a plurality of boundary segments, and selecting one fitting point on each of the boundary segments, to obtain a plurality of fitting points, and a number of the boundary segments is at least six.

5. The method for positioning a pupil according to claim 1, wherein the step of performing boundary extraction on a pupil candidate area in the binary image comprises:
performing exposure processing on the binary image to obtain an exposed binary image; and
performing boundary extraction on the pupil candidate area in the exposed binary image.

6. The method for positioning a pupil according to claim 5, wherein the step of performing boundary extraction on the pupil candidate area in the exposed binary image comprises:
performing an opening operation on the exposed binary image to obtain the binary image after the opening operation; and
performing boundary extraction on the pupil candidate area in the binary image after the opening operation.

7. The method for positioning a pupil according to claim 1, wherein the step of performing boundary extraction on a pupil candidate area in the binary image comprises:
performing an opening operation on the binary image to obtain the binary image after the opening operation; and
performing boundary extraction on the pupil candidate area in the binary image after the opening operation.

8. An apparatus for positioning a pupil, comprising:
a processing circuit configured to acquire an image to be processed, and to pre-process the image to be processed to obtain a binary image;
an extraction circuit configured to perform boundary extraction on a pupil candidate area in the binary image to obtain a pupil candidate boundary corresponding to each pupil candidate area;
a calculation circuit configured to calculate a length of each pupil candidate boundary, and to determine a pupil candidate boundary having the longest length as a target pupil boundary;
an acquisition circuit configured to acquire a plurality of fitting points on the target pupil boundary, and to move the plurality of fitting points in a preset direction by a preset distance to obtain a plurality of target fitting points;
a fitting circuit configured to perform ellipse fitting on the plurality of target fitting points according to Cramer's law to obtain an ellipse, and acquire a center point of the ellipse; and
a determining circuit configured to move the center point in a direction opposite to the preset direction by the preset distance, and to determine the center point after the movements as the pupil.

9. A computer readable storage medium having stored thereon a computer program, when being executed by a processor, the computer program implementing the method for positioning a pupil according to claim 1.

10. An electronic device, comprising:
a processor; and
a memory for storing instructions executable by the processor;
wherein the processor is configured to perform a method for positioning a pupil comprising:
acquiring an image to be processed, and pre-processing the image to be processed to obtain a binary image;
performing boundary extraction on a pupil candidate area in the binary image to obtain a pupil candidate boundary corresponding to each pupil candidate area;
calculating a length of each pupil candidate boundary, and determining a pupil candidate boundary having the longest length as a target pupil boundary;
acquiring a plurality of fitting points on the target pupil boundary, and moving the plurality of fitting points in a preset direction by a preset distance to obtain a plurality of target fitting points;
performing ellipse fitting on the plurality of target fitting points according to Cramer's law to obtain an ellipse, and acquiring a center point of the ellipse;
moving the center point in a direction opposite to the preset direction by the preset distance, and determining the center point after the movements as the pupil.

11. The electronic device according to claim 1, wherein the step of pre-processing the image to be processed to obtain a binary image comprises:
acquiring a grayscale image of the image to be processed;
performing Gaussian filtering on the grayscale image to obtain a de-noised grayscale image; and
converting the de-noised grayscale image into a binary image through a grayscale threshold.

12. The electronic device according to claim 1, wherein the step of performing boundary extraction on a pupil candidate area in the binary image to obtain a pupil candidate boundary corresponding to each pupil candidate area comprises:
respectively extracting boundary points of each pupil candidate area through a boundary detection algorithm; and
performing connected domain analysis on the boundary points of each pupil candidate area to obtain the pupil candidate boundary corresponding to each pupil candidate area.

13. The electronic device according to claim 1, wherein the step of acquiring a plurality of fitting points on the target pupil boundary comprises:
equally dividing the target pupil boundary into a plurality of boundary segments, and selecting one fitting point on each of the boundary segments, to obtain a plurality of fitting points, and a number of the boundary segments is at least six.

14. The electronic device according to claim 1, wherein the step of performing boundary extraction on a pupil candidate area in the binary image comprises:
performing exposure processing on the binary image to obtain an exposed binary image; and
performing boundary extraction on the pupil candidate area in the exposed binary image.

15. The electronic device according to claim 14, wherein the step of performing boundary extraction on the pupil candidate area in the exposed binary image comprises:
performing an opening operation on the exposed binary image to obtain the binary image after the opening operation; and
performing boundary extraction on the pupil candidate area in the binary image after the opening operation.

16. The electronic device according to claim 1, wherein the step of performing boundary extraction on a pupil candidate area in the binary image comprises:
performing an opening operation on the binary image to obtain the binary image after the opening operation; and
performing boundary extraction on the pupil candidate area in the binary image after the opening operation.
